(19) United States
(12) Patent Application Publication
(10) Pub. No.: US 2015/0236538 A1
(43) Pub. Date: Aug. 20, 2015

(54) Mobile Device Case with Fast Charging Battery Pack

(71) Applicant: uNu Electronics, Inc., Union City, CA (US)

(72) Inventors: Sen Cai, Union City, CA (US); Chengping Zhang, Wuhu (CN); Mingquan Mao, Wuhu (CN); Jinsong Wang, Wuhu (CN); Chuanbao Qin, Wuhu (CN)

(21) Appl. No.: 14/543,693

(22) Filed: Nov. 17, 2014

Related U.S. Application Data
(60) Provisional application No. 61/904,795, filed on Nov. 15, 2013.

(51) Int. Cl. H02J 7/00

(52) U.S. Cl. CPC H02J 7/0044; H02J 7/0052

(57) ABSTRACT

A fast charging mobile battery pack is usable to accept approximately 12V DC or between approximately 100V-240V AC and manage the voltage and current levels to rapidly charge a battery of a portable electronic device and/or one or more battery cells within the fast charging mobile battery pack. The fast charging portable battery pack may additionally include multiple output ports to provide different voltage and/or current levels to desired portable electronic devices.

### CROSS-REFERENCE TO RELATED APPLICATIONS

This application claims the benefit of U.S. Patent Application Ser. No. 61/904,795 filed on Nov. 15, 2013, the disclosure of which is hereby incorporated by reference in its entirety.

### BACKGROUND OF THE INVENTION

1. Field of the Invention

Various aspects of this invention relate to external battery packs for mobile devices (such as mobile phones, tablet devices, or similar electronics devices), where the external battery pack can be recharged quickly using an automotive 12V DC outlet (e.g., a cigarette lighter socket) or via an AC outlet. In various embodiments, the recharging speed may be several times faster than commonly seen battery packs in the current market.

2. Background

As electronics devices are becoming more and more popular and people tend to do more outdoor activities or traveling much often, the demand for battery powered devices has increased. With the increased usage of battery operated devices, there is a need for improved methods of charging those devices. Users often rely on dc-to-ac inverters connected to a car battery power outlet and charge their electronics devices through these inverters. These car inverters can convert the car battery's 12v direct current output to 100v-240v alternating current to supply power to external electronics. These kinds of car inverters often require the car to be on or in a “start” state. With the car running, it can waste a lot of gas. Likewise, the device being charged often requires a separate adapter, power strip, and charger for compatible electronic devices to use. The user is thus forced to bring excessive items along when traveling.

### SUMMARY OF THE INVENTION

This invention also relates to a new fast charging mobile portable battery pack. Various exemplary embodiments include the following components: an input charging circuit, a battery module, and an output voltage stabilizer module. In various ones of these exemplary embodiments, the input charging circuit is connected to the battery module, which in turn is connection to the voltage output stabilizer module. The above mentioned battery module may also contain a self-protection circuit. Likewise, the input charging circuit and the voltage stabilizer module may be connected to a digital display circuit. In various exemplary embodiments, the digital display circuit can display the remaining power (i.e., state of charge) of the battery module while the battery pack is being recharged, and it can also display the remaining power (i.e., state of charge) of the battery module when it is discharging (e.g., when being used to charge a mobile device). The disclosed and other embodiments enhance the user's experience and fulfill user needs on the mobile battery pack.

Various battery packs are known in the prior art. However, it has been determined that each of the prior art battery packs fails to provide a satisfactory experience. For example, a certain battery pack is disclosed in Chinese patent number CN202696242. The Portable battery pack disclosed in CN202696242 can only use the color of an LED to indicate an estimated range of the remaining battery in the battery pack. It does not provide specific accurate percentage readings. This is undesirable and creates an inconvenience for users when they try to recharge or discharge the battery pack.

In order to overcome the weakness of the current technology described above, a fast charging portable battery pack that can provide accurate readings for the amount of battery power remaining in the battery pack is desirable.

Accordingly, in various exemplary embodiments, a new fast charging portable battery pack includes the following components: charging circuit, battery module, output voltage stabilizer module. The battery module may also contain a protection circuit. The charging circuit and the voltage stabilization module may be connected to a digital display circuit. In various exemplary embodiments the digital display circuit can display the battery level of the battery module when the battery pack is being recharged, and it can also display the remaining battery level when the battery pack is being discharged.

In various exemplary embodiments, the digital display circuit has one or more voltage and current acquisition chips, an analog to digital converter, and a digital display monitor.

In various exemplary embodiments, the charging circuit utilized an input port that matches the physical and electrical configuration of a power adapter's output port on a personal computer. For example, in various exemplary embodiments, the charging circuit may utilize a barrel plug socket to connect to an AC to DC converter typically used to power and charge laptop batteries. In various other exemplary embodiments, any port or protocol that is capable of providing power may be utilized.

This invention also relates to an in-car fast charging portable battery pack. In various exemplary embodiments, the fast charging portable battery pack is connected to an automobile battery through an electrical port in the vehicle. In such exemplary embodiments, the fast charging portable battery pack includes a charging circuit, a battery module and a voltage stabilizer circuit. In various exemplary embodiments, the fast charging portable battery pack utilizes and input port that is compatible with an electrical outlet or port in an automobile.

In various exemplary embodiments, the voltage stabilization module contains an output circuit featuring standard power output ports that are widely compatible with external electronics digital devices in the market. For example, in various exemplary embodiments, the output circuit may be a USB connection or any other port or protocol that is utilized by other portable electronics devices.

In various exemplary embodiments, the battery module is a single battery or a set of batteries to meet various time charging time requirements of different electronics devices. In various exemplary embodiments, the battery module contains fast charging rechargeable battery cell(s) to reduce the charging time.

In various exemplary embodiments, the charging circuit includes a step-down circuit that protects the battery module(s). In various exemplary embodiments, the stabilizer circuit contains a voltage step-up circuit to increase the voltage of each individually connected single battery to 5V; or a voltage step-down circuit to decrease the voltage of a set of batteries to 5V; or a suitable combination of step-down and step-up circuits together depending on battery set configuration.

In various exemplary embodiments, the voltage stabilization has a single Chip Micyoco control circuit that is usable to control the stability of the battery module's output voltage. In various exemplary embodiments, the charging circuit and the voltage stabilizer module are connected to a digital display circuit. In various ones of these exemplary embodiments, the digital display circuit can display the battery level of the battery module when the battery pack is being recharged, it can also display the remaining power level of the battery module when the battery pack is being discharged. In such embodiments, the user can visualize the accurate remaining power level inside the battery pack.

### BRIEF DESCRIPTION OF DRAWINGS

FIG. 1 is a diagrammatic representation of an exemplary embodiment of a fast charging portable battery pack;

FIG. 2 is a diagrammatic representation of a digital display on the exemplary fast charging portable battery pack of FIG. 1;

FIG. 3 is circuit schematic diagram of the digital display of FIG. 2;

FIG. 4 is circuit schematic diagram of a charging circuit and a voltage stabilizer module for the exemplary fast charging battery pack of FIG. 1;

FIG. 5 is the circuit schematic diagram of a single Chip Micyoco control circuit usable with the exemplary fast charging battery pack of FIG. 1;

FIG. 6 is the circuit schematic diagram of a voltage stabilizer output circuit usable with the exemplary fast charging portable battery pack of FIG. 1;

FIG. 7 is a diagrammatic representation of an exemplary embodiment of a fast charging in-car portable battery pack;

FIG. 8 is a flowchart of a charging control function of the in-car fast charging battery pack of FIG. 7;

FIG. 9 is a circuit schematic of an exemplary fast charging in-car portable battery pack;

FIG. 10 is a structural diagram of a double source portable battery pack;

FIG. 11 is a diagram of a cylindrical batter contact of the double source portable battery pack of FIG. 9;

FIG. 12 is a diagram of the heat dissipation cutouts in an exemplary embodiment of a double source portable battery pack;

FIG. 13 is a rectangular battery implementation diagram;

FIG. 14 is a circuit schematic of a double source portable battery pack;

FIG. 15 is a diagrammatic representation of an embodiment of a portable battery pack that is usable with either a 120V AC wall outlet or a 12V DC automobile outlet.

### DETAILED DESCRIPTION OF PREFERRED EMBODIMENTS

The following description utilizes preferred and other embodiments, applications and figure diagrams to further explain this invention. However, it should be appreciated that the disclosed invention is broader than the discussed embodiments and that other known and later developed components applications and the like may be within the scope of the disclosed invention. The implementations discussed herein are only used to further explain this invention, but it shall not limit the scope of this invention.

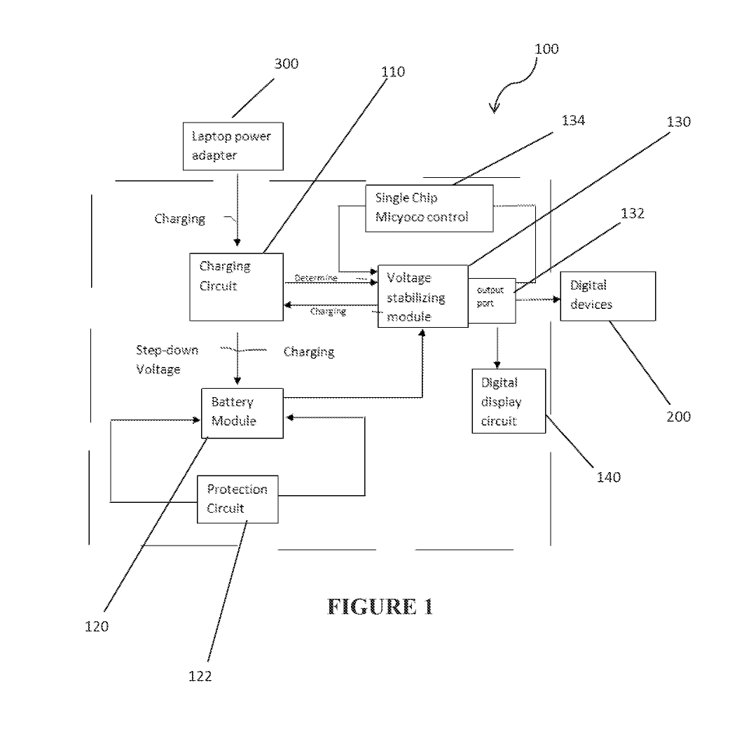

As shown in FIG. 1, exemplary embodiments of a fast charging portable battery pack 100 according to this invention include the following components: an input charging circuit 110, a battery module 120, and an output voltage stabilizer module 130. In various embodiments, and as shown in FIG. 1, the battery module 120 contains or is connected to a self-protection circuit 122. Likewise, in the embodiment shown in FIG. 1, the input charging 110 circuit and the voltage stabilization module 130 are each connected to a digital display circuit 140. The digital display circuit 140 can display the remaining power of the battery module 120 while the battery pack 100 is being recharged, and it can also display the remaining power of the battery module 120 when it is discharging (i.e., when connected to one or more portable electronic device(s) 200 to charge a battery in those device(s)). This configuration may enhance the user experience and fulfill user needs on the mobile battery pack.

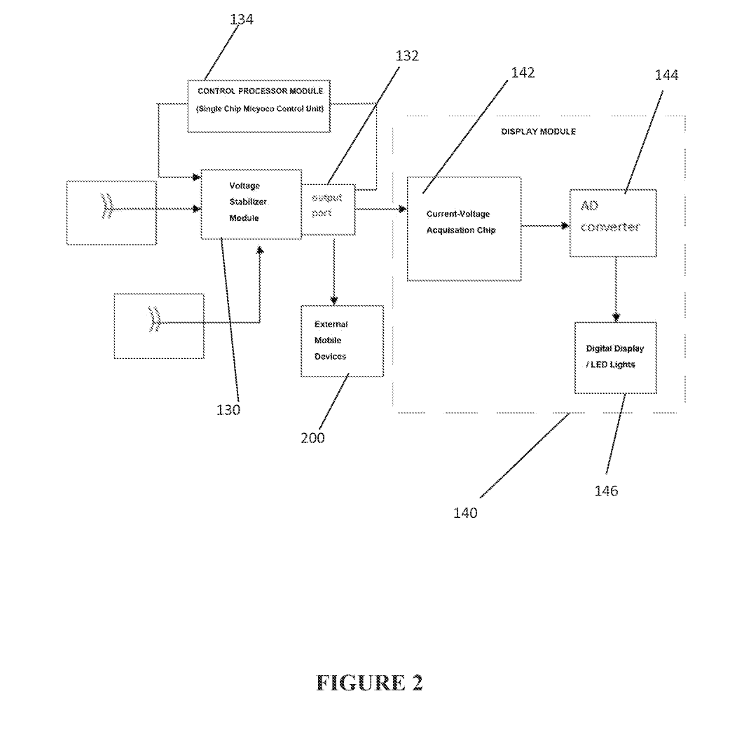

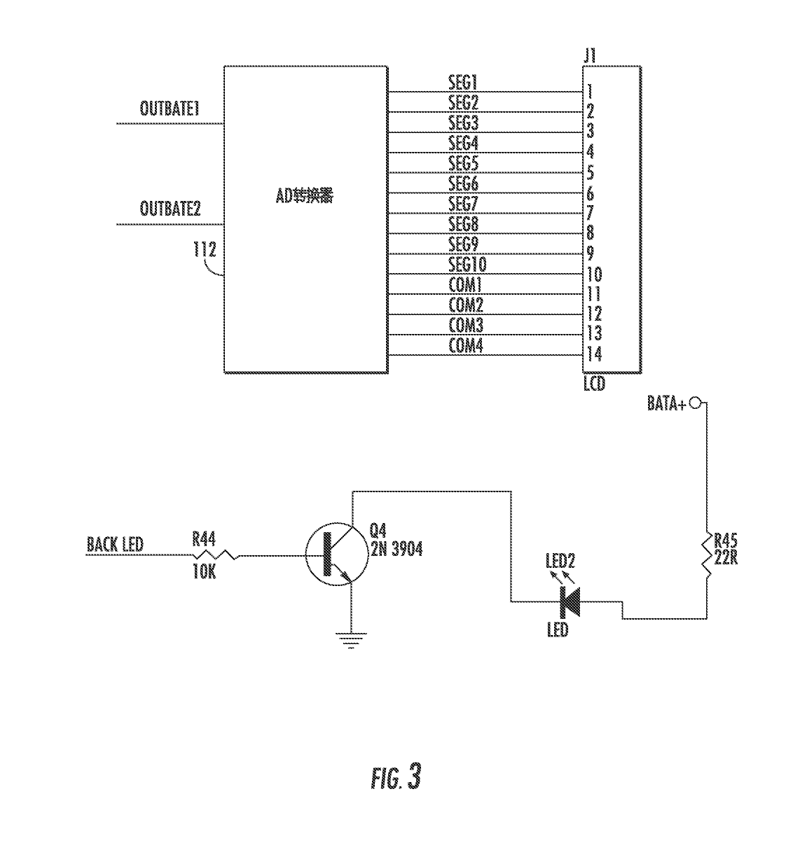

As shown in FIG. 2, in various exemplary embodiments the digital display circuit 140 includes or is connected to a voltage and current acquisition chip 142, an analog to digital (AD) converter 144, and a digital display 146. In various exemplary embodiments, the current and voltage acquisition chip 142 is usable to capture, detect or otherwise determine the remaining battery power from the charging circuit 110 or battery module 120 (such as through connection to the voltage stabilizing module 130) and deliver that information to the AD converter to do the digital computation or conversion. In various exemplary embodiments, the digital display circuit 140 then shows or displays the result on the digital display 146. In this way, a user can visualize the amount of remaining battery level when the battery pack is being recharged or discharged.

It should be appreciated that in various exemplary embodiments, the charging circuit 110 utilizes an input port that matches the physical and electrical configuration of a popular or frequently used port or adapter such as a computer power adapter's output port 300. In various exemplary embodiments, the charging circuit 110 utilizes a barrel plug socket to connect to a AC to DC adaptor typically used to power and charge laptop batteries. Likewise, the voltage stabilization module 130 may utilize an output circuit or port 132 that uses a standard power output port which is compatible with digital devices 200, such as portable electronics devices. In various exemplary embodiments, the output port is a USB port.

In various exemplary embodiments, the battery module 120 is a single battery cell. In various other exemplary embodiments, the battery module 120 includes multiple sets of battery cells to satisfy different kinds of digital device charging demands. The battery module 120 utilizes one or more fast charging rechargeable battery cells to reduce the time to necessary to charge the battery pack 100. In various exemplary embodiments, the charging circuit 110 includes a step-down circuit to protect the battery module 120. In various exemplary embodiments, the stabilization circuit 130 contains a voltage step-up circuit to increase the voltage of a single battery or battery cell to 5V. Likewise, in various exemplary embodiments, the stabilization circuit 130 may include a voltage step-down circuit to decrease the voltage of a set of batteries to 5V. Alternatively, the stabilization circuit 130 may utilize a combination of those step up and step down circuits together. Providing the appropriate voltage can help protect the digital device(s) 200 being charged from the battery pack 100.

In various exemplary embodiments, and as shown in FIG. 1, the voltage stabilization 130 includes or uses a single chip Micyoco control circuit 134. In such exemplary embodiments, the Micyoco control circuit 134 may be usable to control the stability of the output voltage from the battery module 120 to the digital device(s) 200 being charged.

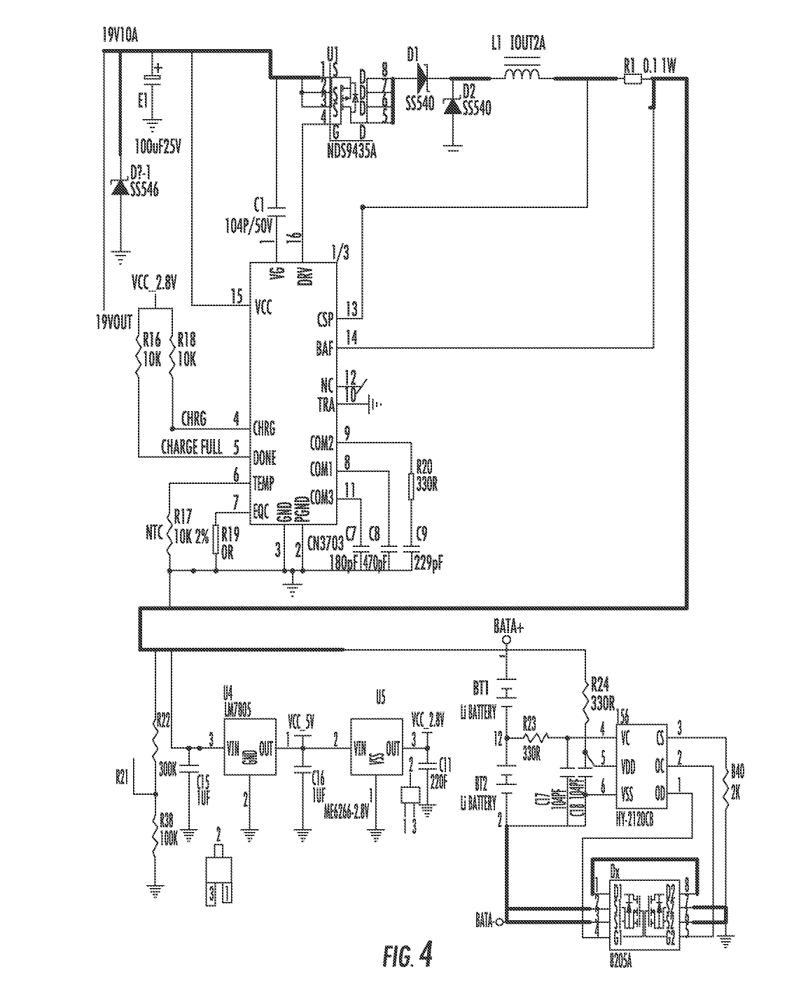

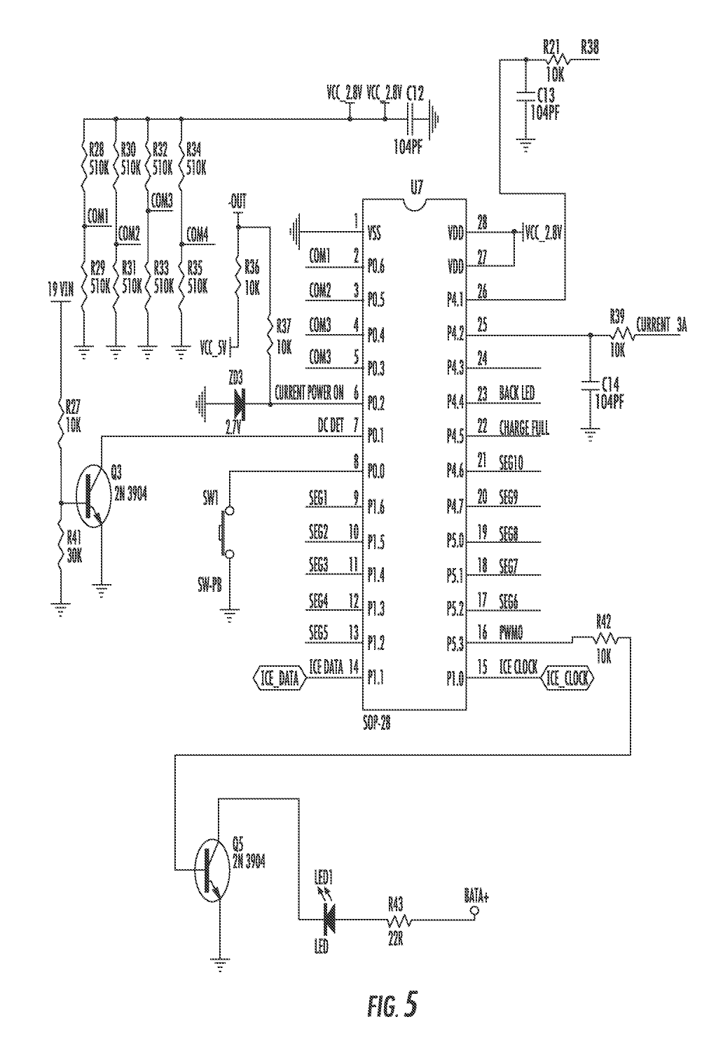

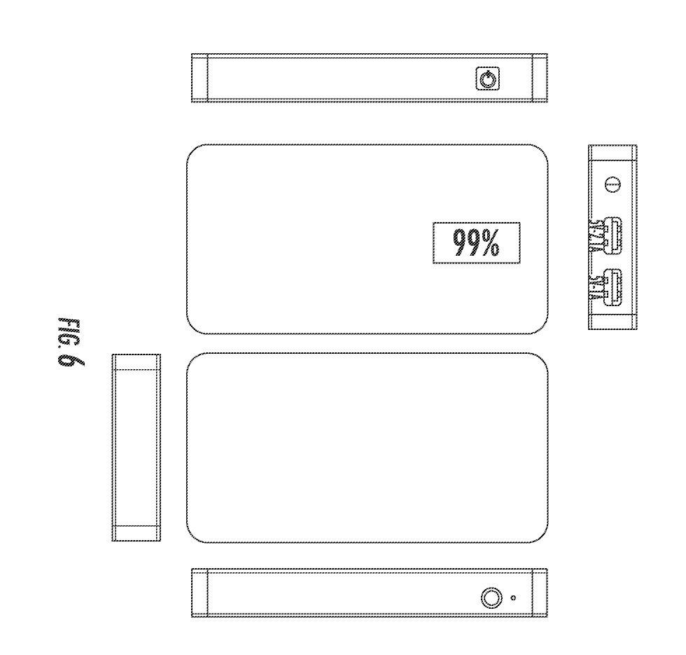

As shown in FIG. 3 to FIG. 6, it shows the circuit diagram of a laptop charger rated at 19V voltage, and it is charging the battery pack. FIG. 3 shows the electricity acquisition chip sends the output analog signals to an analog to digital (A/D) converter 112. The A/D converter 112 converts the analog signal into a digital signal. FIG. 4 shows how the 19V input voltage passes through the charging circuit and gets into the battery module. The voltage passes through the battery module under the control of the protection circuit, and then it is processed at the voltage stabilizer circuit to step-down or step-up to 5V (depending on the type and configuration of battery cells used in the battery module, and the resulting voltage). FIG. 5 is the circuit schematics of the single Chip Micyoco control circuit 134 of the battery pack 100. FIG. 6 is the circuit schematics of the output voltage stabilizer circuit 130.

In the embodiment shown in the figures, the charging circuit and the voltage stabilizer module are connected to a digital display circuit. The digital display circuit can be used to display the power level of the battery module when the battery pack is being charged or discharged.

It should be appreciated that the above-outlined descriptions and figures are exemplary embodiments only and shall not be construed as limiting the scope of the invention. A person of ordinary skill in the art in this technology field can easily learn the aspects of this invention and apply them to other currently existing and later developed components as necessary.

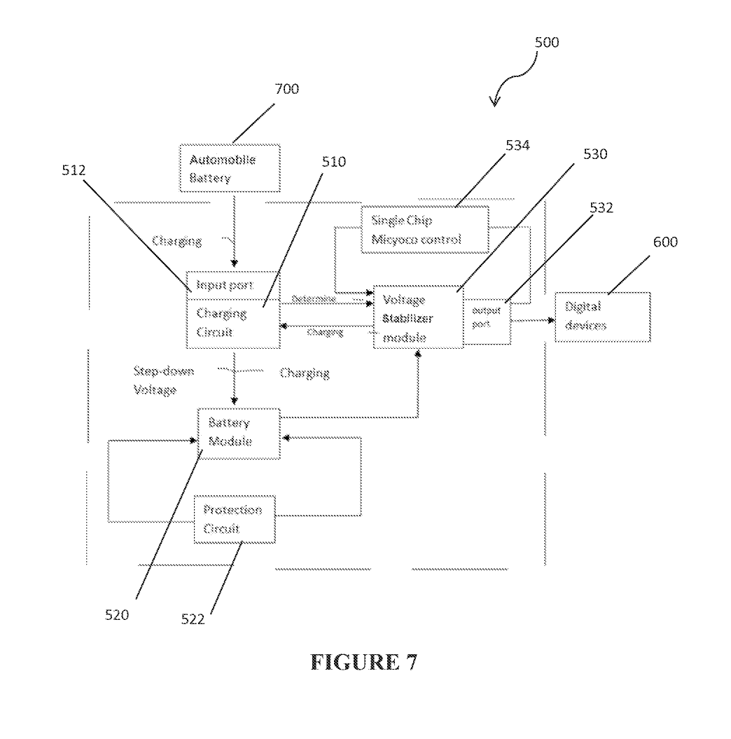

FIGS. 7 through 9 relate to an exemplary embodiment of the present invention that is particularly suited for use in an automobile. In the embodiments shown in FIGS. 7-9, the battery pack 500 is charged via a 12V DC outlet commonly found in automobiles (sometimes, colloquially referred to as cigarette lighter outlets).

In various exemplary embodiments and as shown in FIG. 7, the fast charging portable battery pack 500 includes the following components: a charging circuit 510, a battery module 520, and a voltage stabilizer circuit 530. In this embodiment, the fast charging portable battery pack 500 also includes an input port 512 that is compatible with an electrical port in an automobile. The charging circuit 510 is directly connected to the voltage stabilizer module 530, the fast charging portable battery pack 500 can charge external digital devices 600 by drawing power from the above-mentioned battery module 520. The voltage stabilizer circuit 530 has a standard power output port 532 that is compatible with the external digital devices. In various exemplary embodiments, the output port is a USB port. In this exemplary embodiment, the fast charging portable battery pack 500 can be connected to an automobile battery 700 (through the electrical port in the automobile) and charge digital devices 600 by passing through the power from automobile battery 700; it can also charge its own battery module 520 from the automobile battery 700 so that users can use this fast charging portable battery pack 500 when they leave the automobile. The design can help avoid or limit the use of a battery voltage converter at the point of the automobile electrical port and the elimination of the conversion may help the user save gas by increasing electrical efficiency (thereby reducing the amount of time that an alternator is running to charge the vehicle's battery). The above described embodiments may also eliminate the need to use a battery voltage converter or the need to invert the battery power from 12V DC to an appropriate AC level (such as, for example, 100V-240V AC). In various exemplary embodiments the fast charging portable battery pack 500 features a compact design, and is convenient for users to carry by hand.

In various exemplary embodiments, the battery pack uses a step-down charging circuit and logical control circuit together. The logical control circuit can control the battery pack charging external digital devices by drawing power either from its internal battery module or from automobile battery under the hood.

In various exemplary embodiments, the fast charging battery pack 500 includes a protection circuit 522 in the battery module 520. This protection circuit 522 may be connected with a single battery cell or a set of battery cells depending on the configuration of the battery pack 500.

In various exemplary embodiments, the fast charging battery pack can also indicate the charging status and remaining power of the battery module. In various exemplary embodiments, the fast charging battery pack includes a single chip Micyoco control circuit 534.

In various exemplary embodiments, the fast charging portable battery pack 500 can charge the external device(s) 600 by drawing power from its internal battery module 520 or by forwarding the power from the automobile battery 700. In various exemplary embodiments, the fast charging battery pack 500 does not need to convert the 12V DC provided by the automobile battery 700 to a suitable AC voltage (such as, for example, 100-240V AC). This has the added advantage of reducing a voltage conversion step (thereby eliminating inefficiencies) and reduces the number of chargers and cables necessary to charge multiple items.

In addition to charging external digital devices 600 by forwarding power from the automobile batter 700, various exemplary embodiments are also able to recharge the battery module 520 from the automobile battery 700. As such, the fast charging battery pack can provide additional battery power to portable devices when away from other power sources.

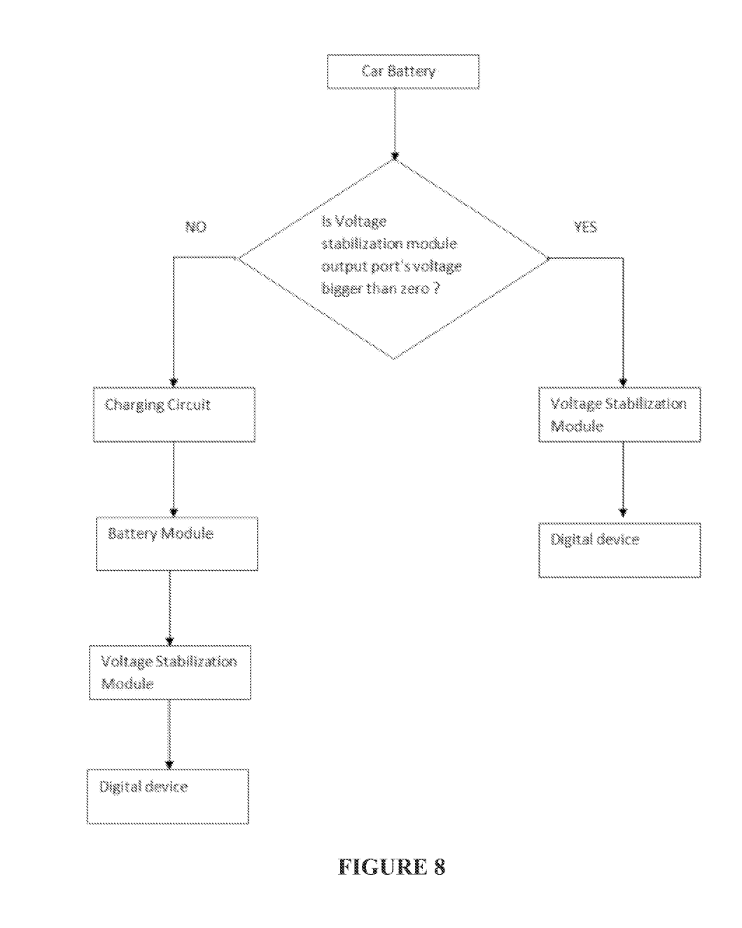

As shown in FIG. 8, in various exemplary embodiments, the fast charging portable battery pack uses a step-down charging circuit and logical control circuit together. The logical control circuit can control the battery pack to charge digital devices by either drawing power from its internal battery or by forwarding power from the car battery. This fast charging portable battery pack also has a Single Chip Micyoco control circuit and it is used to control the output of this battery pack.

Battery module includes a fast charging rechargeable battery core. This fast charging battery core may be a single cell or a set of battery cells.

In various exemplary embodiments, there is a protection circuit in the battery module. This protection circuit may be connected to the single battery cell or the set of battery cells.

In various exemplary embodiments, the circuit also contains a display unit which can indicate the charging status and remaining power in the battery module. In various exemplary embodiments, this unit is connected to the single Chip Micyoco control circuit.

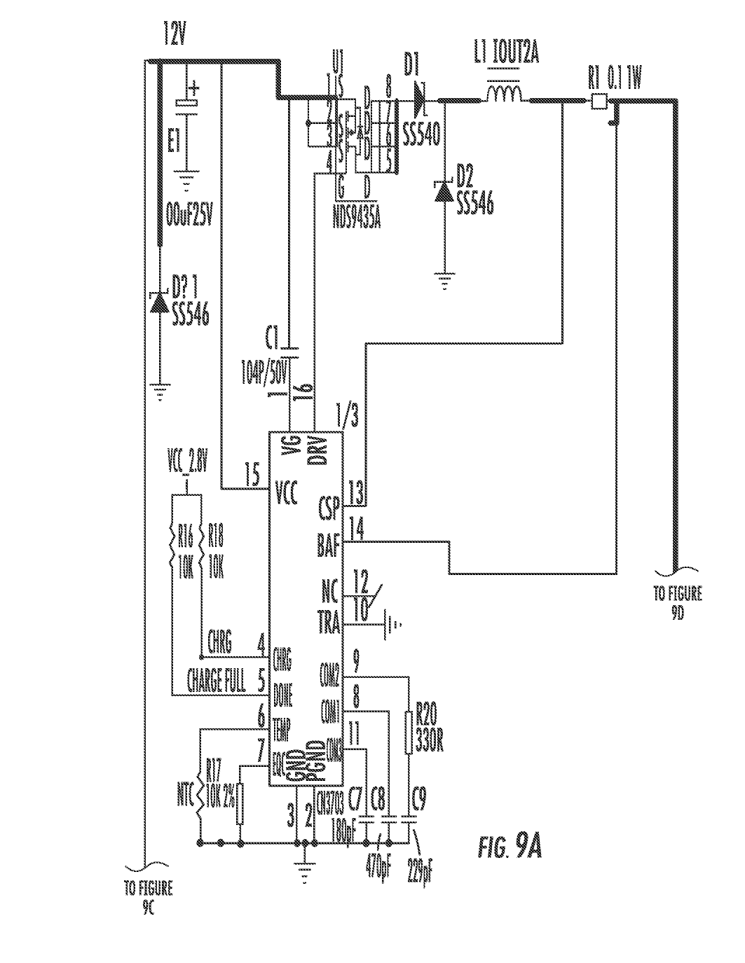

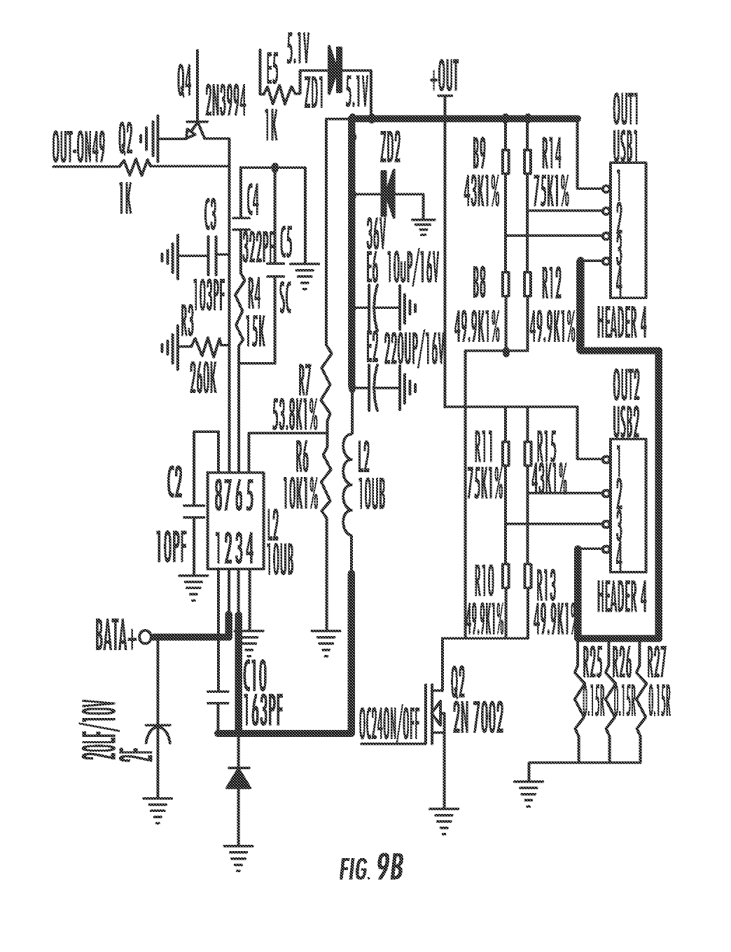

As shown in the exemplary embodiment shown in FIG. 9, the fast charging portable battery pack output port is 12v DC, this current goes through battery chip's CHRG port to reach the input charging circuit. After it goes through the voltage stabilizer circuit, the forwarded power is ready to charge a portable electronic device, such as an iPad/MID an iPhone/MP3 player or the like.

This fast charging portable battery pack can be directly connected to an automobile battery and directly charge digital devices from there; it can also charge its battery module from car storage battery so that users can use this fast charging portable battery pack when they leave the car.

Also disclosed is a double source portable battery pack. This portable battery pack has a detachable top cover portion and a lower case portion that the top cover can fit into. In various exemplary embodiments, the lower case portion includes an extrusive circuit board, and a battery compartment. Inside the battery compartment, there is a middle divider panel that separates the compartment into two sections. Between the divider panel and the top cover portion, it forms a space to enclose swappable batteries. Between the divider panel and the bottom panel of the lower case portion, it encloses the internal rechargeable battery. There are several horizontal sets of cylindrical battery contacts featured inside the swappable battery slot. There are several vertical sets of contacts for connected to internal battery inside the same space. A cylindrical battery is placed in the slot and connected to every cylindrical battery contacts. This invention uses the swappable cylindrical battery as the portable battery pack's main power source and use the internal battery as the supplementary power source. By leaving the space and connect contacts for swappable batteries, the pack is more user friendly. This design provides convenience for customers, fulfills customer's needs, helps to improve the reliability of the battery pack, maximizes the customer's satisfaction, and also reduces costs to the end user by eliminating the need for multiple battery packs.

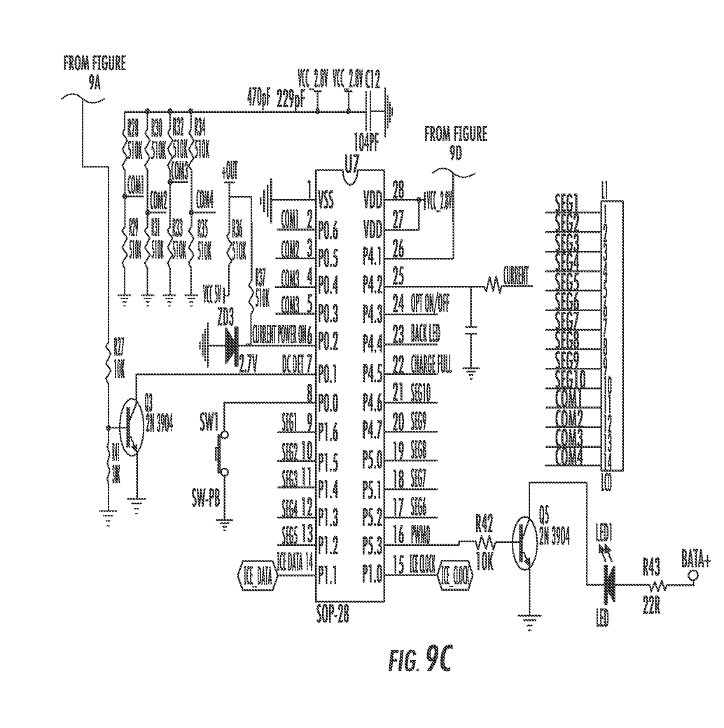

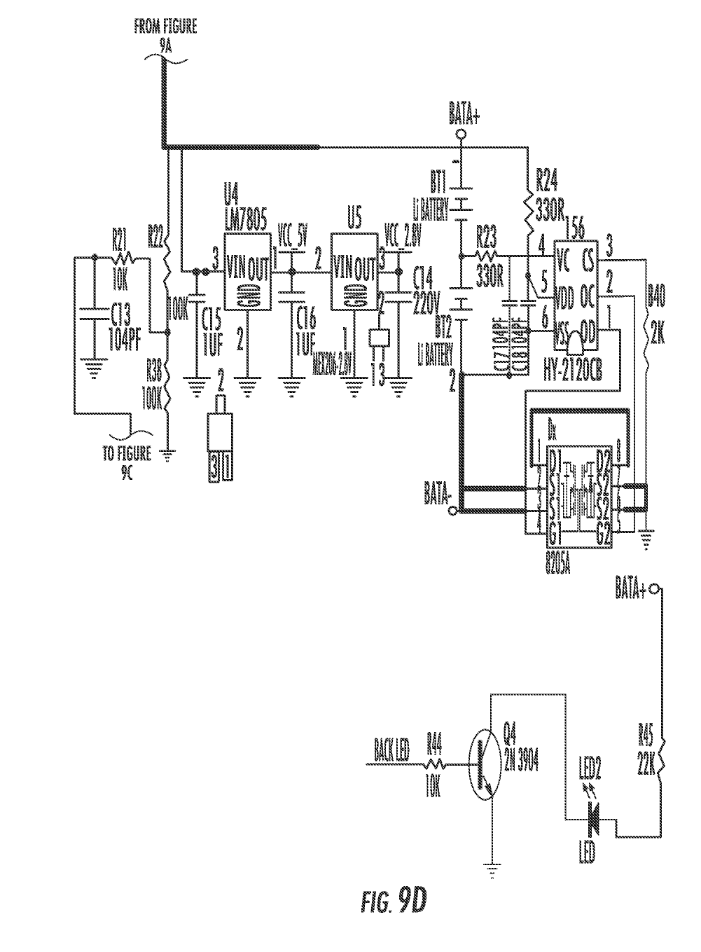

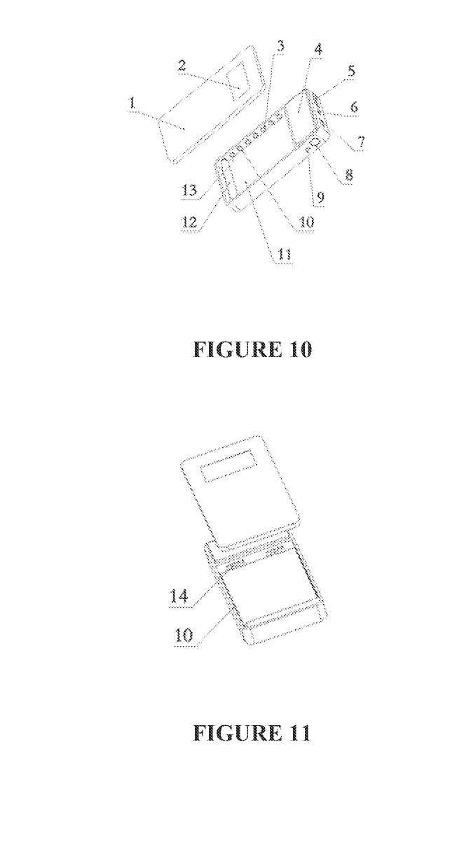

In various exemplary embodiments, and as shown in FIGS. 10-14, a double power source portable battery pack includes a detachable top cover portion 1, and a lower case portion 3 that can couple with the top cover portion 1. Inside the lower case portion 3 is an extrusive circuit board 4. In various exemplary embodiments, the battery pack further includes a battery compartment 11 inside the lower case portion 3. The battery compartment 11 has a middle divider panel 13. In various exemplary embodiments, an internal rechargeable battery is placed between the middle divider panel 13 and the lower case portion 3. Additionally, in various exemplary embodiments, at least one swappable battery is placed between the middle divider panel 13 and the top cover portion 1. Various exemplary embodiments include multiple horizontal sets of cylindrical battery contacts 10 inside a swappable battery compartment. Likewise, several vertical sets of battery contacts may be provided inside the swappable battery compartment connecting to the internal rechargeable battery 14.

In various exemplary embodiments, depending on how users use this product, the two battery sources can be selected to provide power to external electronic devices. This design helps to supply power to electronics devices when user needs be far away from power outlets for extended periods of time.

In various exemplary embodiments, for each of the mentioned cylindrical battery contacts 10, there is a cylindrical battery placed and connected. For each of set of contacts for internal battery, there is a rectangular battery attached. With those two power sources, it can provide additional power required by the user.

In various exemplary embodiments, the bottom panel of the lower case has several heat dissipation cutouts, which helps to extend the life of the battery cells and the battery pack.

In various exemplary embodiments on one sidewall of the lower case, there is a charging input port and charging output ports of the portable battery pack. The described charging output ports are compatible with electronic devices. One port output has a first voltage potential and a first current limit. The other output port has a second voltage potential and second current limit.

In various exemplary embodiments the lower case sidewall has a power switch and a battery status switch. The battery status switch can toggle to display the internal rechargeable battery and external swappable battery's charging status.

In various exemplary embodiments, the top cover has a display; this display shows the remaining power of the enclosed batteries.

In various exemplary embodiments the battery compartment includes a middle divider panel that separates the compartment into two sections. Between the divider panel and the top cover portion, it forms a space to enclose swappable batteries. Between the divider panel and the bottom panel of the lower case portion, it encloses the internal rechargeable battery. Various exemplary embodiments include several horizontal sets of cylindrical battery contacts featured inside the swappable battery slot. Various exemplary embodiments include several vertical sets of contacts for connection to internal batteries inside the same space. A cylindrical battery may be placed in the slot and connected to any of the cylindrical battery contacts. The battery source may be toggled to provide output power according to how user uses the product.

Various exemplary embodiments use the swappable cylindrical battery as the portable battery pack's main power source and use the internal battery as the supplementary power source.

As shown in FIG. 10, an exemplary double power source portable battery pack has a detachable top cover portion 1, and a lower case portion 3 that can couple with the top cover portion 1. Inside the lower case portion 3 is an extrusive circuit board 4. In various exemplary embodiments, a battery compartment 11 is located on one end of the lower case portion 3. In various exemplary embodiments, the battery compartment 11 has a middle divider panel 13. An internal rechargeable battery may be placed between the middle panel 13 and the lower case portion 3. Likewise, swappable batteries may be placed between the middle divider plate 13 and the top cover portion 1. Various exemplary embodiments include several horizontal sets of cylindrical battery contacts 10 inside swappable battery compartment. Additionally, there may be several vertical sets of battery contacts inside the swappable battery compartment connecting to the internal rechargeable battery 14.

As shown in FIGS. 10 and 11, various exemplary embodiments of double source portable battery packs include a cylindrical battery 12 placed and connected to each cylindrical battery contact 10. Various other exemplary embodiments include an internal rectangular rechargeable battery 17 placed and connected to each internal battery contact. In various exemplary embodiments, on one sidewall of the lower case portion 3, there is a charging input port 6 and charging output ports. The charging output ports are compatible with electronic devices. In various exemplary embodiments, the port 7 has a voltage of 5V DC and a maximum current output of 2.1 A. Meanwhile a second port 5 has a voltage of 5V DC, a maximum current of 10 A.

The lower case portion 3 sidewall has a power switch 8, battery status switch 9 of the portable battery pack. A battery status switch can toggle to display the internal rechargeable battery and external swappable battery's charging status.

In various exemplary embodiments, the top cover portion 3 has a display 2, this display 2 may show the remaining power of the enclosed batteries.

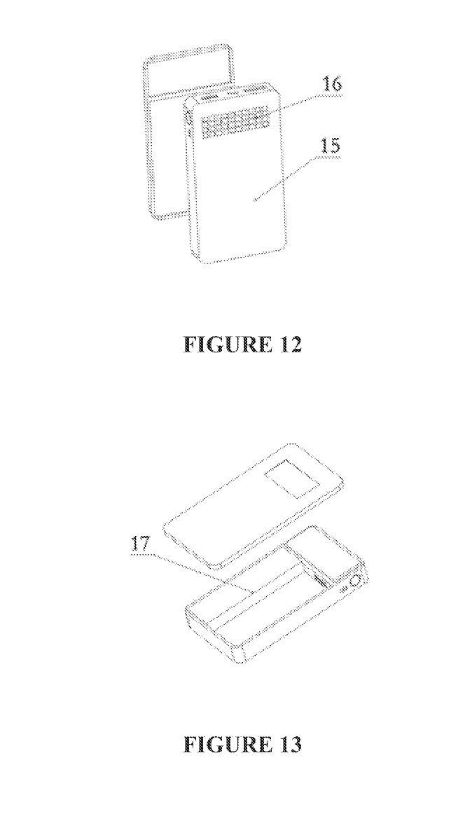

As shown in FIG. 12, in various exemplary embodiments there are several heat dissipation cutouts 16 on the bottom panel 15 of the lower case portion 3, which helps prolong the battery life of the battery cells and the battery pack.

When using this portable battery pack, either rectangular or cylindrical battery cells can be used. Rectangular battery and cylindrical battery cells, however cannot be used together. In addition, the cylindrical battery can be AA or AAA batteries, and the rectangular battery may be a lithium type battery, such as a lithium ion battery or a lithium polymer. Each battery cell may have a voltage ranging from between approximately 3.5V and approximately 5.5V DC

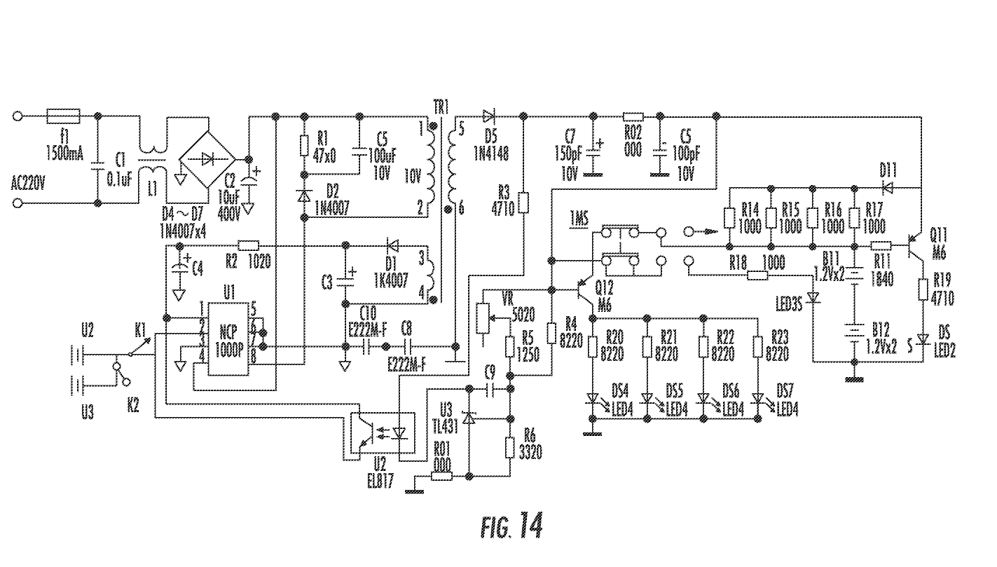

FIG. 14, shows an exemplary circuit schematic of a double source portable mobile battery pack featuring 7500 mah battery cell.

Various exemplary embodiments utilize the swappable cylindrical battery as the portable battery pack's main power source and use the internal battery as a supplementary power source.

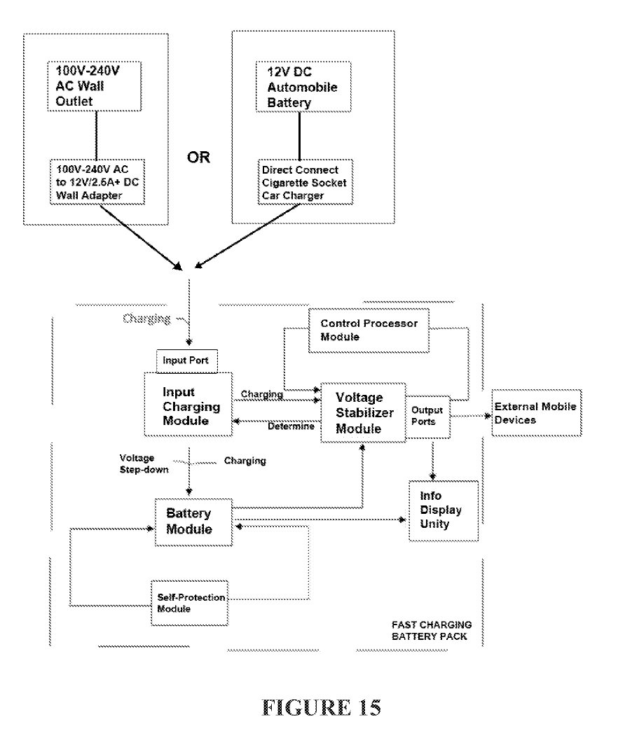

As shown in FIG. 15, the embodiments of FIGS. 1 and 2 can be combined with the embodiment shown in FIG. 7 such that a single fast charging portable battery pack can be used with either a 100V-240V AC wall outlet or a 12V DC automobile battery (through an electrical connection in the vehicle.

It should be appreciated that various exemplary embodiments may require a minimum of 2 battery cells connected in series with each other. Various ones of these exemplary embodiments may additionally have battery cells connected in parallel to each other. Various exemplary embodiments may have multiple sets of 2 or more battery cells connected in series with each with two or more of the multiple sets connected in parallel with each other. For example, various exemplary embodiments may have or may require two battery cells connected in series with each other and connected in parallel to a second set or two battery cells that are connected in series with each other.

With further reference to FIG. 15, in various exemplary embodiments, the input charging circuit module is connected to the input port and will receive input power from the input port. At the same time, it may be connected to the battery module and will step down or step up the power received from the input port to match the battery module total voltage and recharge the battery cells in it. In various exemplary embodiments, the input charging circuit is also connected to the voltage stabilizer module, and the voltage power received from the input port can be processed at voltage stabilizer module to step down or up to match and recharge the external devices through the output port under the control of the processor.

In various exemplary embodiments, the battery module contains a set of battery cells with rated voltage ranging from 3.5V˜5V, and those battery cells are connected in a configuration in which a minimum of 2 battery cells are connected in series. In various exemplary embodiments, each cell receive no less than 2 A or higher charging current while the battery module is being recharged.

In various exemplary embodiments, the battery cells in the battery module are lithium polymer type and featuring rated voltage ranging from 3.5V˜5V. In various exemplary embodiments each battery cells is ensured its maximum usable capacity not to degrade to 80% of its rated capacity within 500 recharge-discharge cycles, and its volume not to pop greater than 5% while being charged at 2 coulombs power under an environment with a constant temperature of 85 degree Celsius or under.

In various exemplary embodiments, the battery module is connected to the input charging circuit. The input charging circuit may step down or step up the voltage to match the battery module's rated voltage in order to recharge the battery module. During this process, in various exemplary embodiments, a minimum of 2 battery cells in the battery module will receive at least 2 A current while being charged.

Various exemplary embodiments also include a self-protection circuit. The protection circuit will cut off the connection of the battery module when extreme conditions happen to any cells in the battery module. The extreme conditions include but are not limited to battery short circuit, battery overheat, severe physical shocks and the like.

In various exemplary embodiments, the voltage stabilizer circuit has one or more standard power output ports featuring a rated voltage ranging from 3.5V˜5.5V which are compatible to a wide selection of external mobile devices. The voltage stabilizer may be connected to the battery module, input charging circuit, and control processor module. In various exemplary embodiments, the output ports can charge external mobile devices by drawing power from the battery module, such power will pass through the voltage stabilizer and step down to a voltage ranging from 3.5V˜5.5V and deliver to external mobile device via output ports. While the input charging port is connected to 12V 2.0 A+DC, under the supervision of the control processor the voltage stabilizer module can also receive power from input charging circuit, step down the voltage to a voltage ranging from 3.5˜5.5V, forward to the output ports and charge the external mobile devices.

In various exemplary embodiments, an optional display module is connected to the input charging circuit and the voltage stabilization module. The display module is comprised of a display or a plurality of LEDs, voltage-current acquisition chip and analog to digital (AD) converter. The display or LEDs can display various information about the battery module (i.e. battery level, charging time, battery status and the like) while the battery pack is being recharged or discharged. In various exemplary embodiments, the display results are computed in the AD converter using the data collected by acquisition chip.

1. A fast charging portable battery pack includes:
a charging circuit;
a battery module, the battery module containing a protection circuit; and
an output voltage stabilization circuit.

2. The fast charging portable battery pack of claim 1, further including a digital display circuit wherein the charging circuit and the voltage stabilization circuit are each couple at least indirectly to the digital display circuit.

3. The fast charging portable battery pack of claim 2, wherein the digital display circuit is further connected to a current and voltage acquisition chip.

4. The fast charging portable battery pack of claim 2, further comprising a control processor.

5. The fast charging portable battery pack of claim 1, wherein the charging circuit is connected to at least one of a standard AC wall outlet or an automotive 12 V DC outlet.

6. The fast charging portable battery pack of claim 1, wherein the battery module includes one or more lithium polymer battery cells, each lithium polymer battery cell having a voltage ranging between approximately 3.5 and 5.5V.

7. The fast charging portable battery pack of claim 6, wherein the one or more lithium polymer battery cells include at least two battery cells that are connected in series to each other.

8. The fast charging portable battery pack of claim 6, wherein the one or more lithium polymer battery cells include at least two battery cells that receive a minimum of 2 A of current when being recharged.

9. The fast charging portable battery pack of claim 8, wherein an input voltage is stepped up to a higher voltage to match a rated voltage of the battery module.

10. The fast charging portable battery pack of claim 8, wherein an input voltage is stepped down to a lower voltage to match a rated voltage of the battery module.

11. A method of charging a portable electronic device comprising:
connecting a portable battery pack to an electrical source;
charging the portable battery pack from the electrical source; and
charging the portable electronic device from the portable battery pack;
wherein, the portable battery pack is configured to charge at a faster rate than the portable electronic device.

12. The method of claim 11, further comprising disconnecting the portable battery pack from the electrical source before charging the portable electronic device from the portable battery pack.

13. The method of claim 12, wherein the portable electronic device is connected to the portable battery pack while the portable battery pack is being charged from the electrical source.

14. The method of claim 13, further comprising charging the portable electronic device from the portable battery pack while the portable battery pack is being charged from the electrical source.

15. The method of claim 11, wherein the electrical source is a 12V DC power source.

16. The method of claim 15, wherein the 12V DC power source is an automobile battery.

17. The method of claim 11, wherein the electrical source is a 120V AC wall outlet.

18. The method of claim 11, wherein charging the portable battery pack from the electrical source further comprising providing an electrical current to the portable battery pack of approximately 2 A.

19. The method of claim 11, wherein charging the portable battery pack from the electrical source further comprising providing an electrical current to the portable battery pack of more than 2 A.

20. A method of charging a portable electronic device comprising:
connecting a portable battery pack to an electrical source, the battery pack comprising one or more lithium ion cells;
charging the portable battery pack from the electrical source;
connecting the portable battery pack to a portable electronic device, the portable electronic device having a rechargeable battery; and
providing an electrical current to the portable electronic device from the portable battery pack to charge the rechargeable battery of the portable electronic device;
wherein charging the portable battery pack comprises providing an electrical current of at least 2 A to the one or more lithium ion cells; and
wherein charging the portable battery pack is conducted at a faster rate of charge than charging the rechargeable battery of the portable electronic device.
